(19) United States
(12) Patent Application Publication
(10) Pub. No.: US 2026/0264622 A1
(43) Pub. Date: Sep. 10, 2026

(54) VEHICLE ROOF CROSSBAR

(71) Applicant: Ningbo Pinchuan Auto Parts Co., Ltd, Ningbo (CN)

(72) Inventor: Jichao ZENG, Ningbo (CN)

(21) Appl. No.: 19/194,340

(22) Filed: Apr. 30, 2025

(30) Foreign Application Priority Data
Mar. 8, 2025 (CN) 202510273459.7

(51) Int. Cl. B60R 9/045; B60R 9/052

(52) U.S. Cl. CPC B60R 9/045; B60R 9/052

(57) ABSTRACT

A vehicle roof crossbar includes a crossbar main body and a sliding seat. A first sliding groove is formed at a bottom of the crossbar main body. The sliding seat includes a first slider, a seat body, a first screw rod, a first clamping block and a second clamping block. The first slider is arranged on a top of the seat body and is slidably connected to the crossbar main body, the first screw rod is arranged inside the seat body and is configured to rotate around its axis, and the first clamping block includes a connecting block and a clamping block. A first connecting portion is arranged at a bottom of the connecting block, a top of the clamping block is provided with a second connecting portion, and the connecting block and the clamping block are detachably assembled.

### CROSS REFERENCE TO RELATED APPLICATIONS

This application claims priority benefits to Chinese Patent Application No. 2025102734597, filed on Mar. 08, 2025, the contents of which are incorporated herein by reference.

### TECHNICAL FIELD

The present disclosure relates to the technical field of automotive accessories, and in particular to a vehicle roof crossbar.

### BACKGROUND

A vehicle roof crossbar is an important accessory in the automotive field and is generally used as a luggage rack or a handrail crossbeam.

The common crossbar accessories currently available on the market usually adopt a sheet metal structure, and a plurality of layers of internal and external sheet metals are interlocked horizontally or vertically to form the crossbar and clamping structure.

However, due to process and structural limitations, the common crossbar structures on the market lack a position-adjustable linkage mechanism between their clamping structures. Therefore, these crossbar structures are difficult to adapt to various types of longitudinal rails, leading to a single function and failing to satisfy the use requirements of various types of vehicles.

Therefore, there is an urgent need to solve the technical problem of how to make the clamping structure on the vehicle roof crossbar satisfy the clamping requirements of a variety of different roof longitudinal rails.

### SUMMARY

The objective of the present disclosure is to provide a vehicle roof crossbar to at least solve the technical problems existing in the above existing products.

In order to achieve the above objective, the present disclosure provides the following technical solutions: the present disclosure provides a vehicle roof crossbar, including a crossbar main body and a sliding seat, where the crossbar main body extends along a horizontal direction, a first sliding groove is formed at the bottom of the crossbar main body, and the first sliding groove extends in a same direction as the crossbar main body and penetrates two ends in an extension direction of the crossbar main body; the sliding seat includes a first slider, a seat body, a first screw rod, a first clamping block and a second clamping block, where the first slider is arranged on the top of the seat body and is configured to being slidably connected to the crossbar main body through the first sliding groove, the first screw rod is arranged inside the seat body and extends in the same direction as the crossbar main body, the first screw rod is configured to rotating around its axis relative to the seat body, the first clamping block includes a connecting block and a clamping block, the connecting block and the second clamping block are sequentially threaded through by the first screw rod, the second clamping block is in threaded connection with the first screw rod, a first connecting portion is arranged at the bottom of the connecting block, a second connecting portion that matches the first connecting portion is arranged on the top of the clamping block, and the connecting block and the clamping block are detachably assembled through the first connecting portion and the second connecting portion; where, when the first screw rod rotates, a spacing between the first clamping block and the second clamping block may be adjusted.

Further, in some implementation solutions of the vehicle roof crossbar, the sliding seat further includes a first spring, a second spring and a ring-shaped buckle; where the connecting block defines a first through hole, a limiting structure is arranged inside the seat body, a second through hole is formed in the limiting structure, the first screw rod is sequentially threaded through the first through hole and the second through hole and then is in threaded connection with the second clamping block, and two ends in an extension direction of the second through hole are respectively provided with a first end face and a second end face; the first spring is threaded through by the first screw rod, and two ends of the first spring respectively abut against the connecting block and the first end face; the second spring is threaded through by the first screw rod, and two ends of the second spring respectively abut against the second end face and the second clamping block; and the ring-shaped buckle is buckled with a tail end of the first screw rod.

Further, in some implementation solutions of the above vehicle roof crossbar, the sliding seat further includes a locking portion, where the locking portion includes a first end cover and a lock cylinder arranged on the first end cover, the first end cover is detachably connected to a side of the seat body corresponding to the first clamping block, such that the first end cover covers the first through hole, and a locking structure adapted to the lock cylinder is provided at a position corresponding to the lock cylinder on the seat body.

Further, in some implementation solutions of the above vehicle roof crossbar, the vehicle roof crossbar further includes a second screw rod and a mounting strip, where the mounting strip is placed in the first sliding groove through interference fit, the first slider defines a third through hole, and the second screw rod is threaded through the third through hole and then is in threaded connection with the mounting strip.

Further, in some implementation solutions of the above vehicle roof crossbar, the vehicle roof crossbar further includes a second slider, where the second slider defines a fourth through hole, the second screw rod is sequentially threaded through the second slider and the first slider and then is in threaded connection with the mounting strip, a side of the second slider proximal to the first slider is provided with a first inclined surface, and a second inclined surface that matches the first inclined surface is arranged on the first slider corresponding to the first inclined surface; where, when the second screw rod is locked, the first inclined surface abuts against the second inclined surface.

Further, in some implementation solutions of the above vehicle roof crossbar, the vehicle roof crossbar further includes a filling strip, where a second sliding groove is formed at the top of the crossbar main body, the filling strip is placed in the second sliding groove through interference fit, and the top of the filling strip defines a strip-shaped gap extending in the same direction as the crossbar main body.

Further, in some implementation solutions of the above vehicle roof crossbar, the vehicle roof crossbar further includes a limiting end cover and a second end cover, where the limiting end cover is buckled at an end of the crossbar main body to close an end of the first sliding groove, an adjustment hole and a shaft hole are formed in the limiting end cover, the adjustment hole corresponds to a position of the second screw rod, a pin shaft is arranged on the second end cover corresponding to the shaft hole, and the second end cover is rotatably connected with the shaft hole through the pin shaft.

It can be known based on the analysis that, compared with the existing similar products on the market, the vehicle roof crossbar of the present disclosure can be adjusted in three ways to satisfy the clamping requirement of vehicle roof longitudinal rails of various models and sizes. When a user needs to adjust the spacing between the first clamping block and the second clamping block in the sliding seat, by rotating the first screw rod and under elastic forces of the first spring and the second spring, the first clamping block and the second clamping block may approach or move away from each other synchronously, thereby adjusting the spacing between the first clamping block and the second clamping block. When the user needs to adjust a position of the sliding seat on the crossbar main body, by rotating the second screw rod and under the action of gravity, the first inclined surface on the second slider may be separated from the second inclined surface on the first slider. At this time, the second slider may be slid to change the position of the sliding seat on the crossbar main body. After the sliding seat is slid to a target position, the second screw rod is rotated and locked, such that the first inclined surface on the second slider fits with and abuts against the second inclined surface on the first slider, so as to finally form an interaction force, enable the first slider and the second slider to respectively press against groove walls of the first sliding groove on the crossbar main body, and achieve a final fixing effect. When the user needs to clamp vehicle roof longitudinal rails with other cross-sectional shapes, the clamping block in the first clamping block may be removed from the connecting block, and a clamping block with a corresponding shape may be selected for replacement according to a cross-sectional shape of a vehicle roof longitudinal rail to be clamped, so as to satisfy the clamping requirement of vehicle roof longitudinal rails with different cross-sectional shapes. A corresponding locking portion is arranged on the sliding seat in the vehicle roof crossbar, and the locking portion covers and protects the first screw rod to prevent non-operators from adjusting or stealing the sliding seat. The second sliding groove at the top of the crossbar main body of the vehicle roof crossbar is filled with a filling strip made by an extrusion molding process. A strip-shaped gap is formed on the top of the filling strip. When the user needs to mount the crossbar main body through a T-shaped screw rod, a utility knife or other thin-sheet-shaped mounting tools may be used to scrape the strip-shaped gap, and then the corresponding T-shaped screw rod may be slid into along the second sliding rail and the strip-shaped gap, with no need for cutting off and refilling the filling strip, thereby effectively improving working efficiency of the installation personnel.

### BRIEF DESCRIPTION OF THE DRAWINGS

The accompanying drawings of the specification constituting a part of the present disclosure are used to provide a further understanding of the present disclosure. Schematic embodiments of the present disclosure and their descriptions are used to explain the present disclosure and do not constitute an improper limitation of the present disclosure, in the figures.

FIG. 1 is a perspective view of a vehicle roof crossbar according to an embodiment of the present disclosure.

FIG. 2 is a partial perspective view of a vehicle roof crossbar according to an embodiment of the present disclosure.

FIG. 3 is a partial sectional view of a vehicle roof crossbar according to an embodiment of the present disclosure.

FIG. 4 is an exploded perspective view of a partial structure of a vehicle roof crossbar according to an embodiment of the present disclosure.

FIG. 5 is a perspective view of a working state of a second end cover in a vehicle roof crossbar according to an embodiment of the present disclosure.

FIG. 6 is a comparative perspective view before and after replacing a clamping block in a vehicle roof crossbar according to an embodiment of the present disclosure.

Reference numerals in the figures: 1. crossbar main body; 101. first sliding groove; 102. second sliding groove; 2. sliding seat; 201. first slider; 201a. third through hole; 202. seat body; 203. first screw rod; 204. first clamping block; 204a. connecting block; 204b. clamping block; 204c. first connecting portion; 204d. second connecting portion; 204e. first through hole; 205. second clamping block; 206. limiting structure; 206a. second through hole; 207. locking portion; 207a. first end cover; 207b. lock cylinder; 208. locking structure; 3. first spring; 4. second spring; 5. ring-shaped buckle; 6. second screw rod; 7. mounting strip; 8. second slider; 801. fourth through hole; 9. filling strip; 901. strip-shaped gap; 10. limiting end cover; 1001. adjustment hole; 1002. shaft hole; 11. second end cover; 1101. pin shaft; 12. T-shaped screw rod; 13. first vehicle roof longitudinal rail; 14. second vehicle roof longitudinal rail.

### DETAILED DESCRIPTION

The present disclosure will be described in detail below with reference to the accompanying drawings and in combination with the embodiments. Each example is provided by way of explanation of the present disclosure and does not limit the present disclosure. In fact, those skilled in the art will clearly understand that modifications and variations may be made to the present disclosure without departing from the scope or spirit of the present disclosure. For example, features shown or described as part of one embodiment may be used in another embodiment to produce yet another embodiment. Therefore, it is desired that the present disclosure includes such modifications and variations that fall within the scope of the appended claims and their equivalents.

In the description of the present disclosure, the orientation or positional relationships indicated by the terms "longitudinal", "transverse", "upper", "lower", "front", "rear", "left", "right", "vertical", "horizontal", "top", "bottom" are based on the orientation or positional relationships shown in the accompanying drawings, and are merely for the convenience of describing the present disclosure rather than requiring the present disclosure to be constructed and operated in a specific orientation. Therefore, they should not be construed as a limitation to the present disclosure. The terms "connected", "connection", and "arranged" used in the present disclosure should be understood in a broad sense. For example, the connection may be a fixed connection or a detachable connection; it may be a direct connection or an indirect connection through an intermediate component; and it may be a wired electrical connection, a radio connection, or a wireless communication signal connection. For those skilled in the art, the specific meanings of the above terms may be understood according to specific situations. One or more examples of the present disclosure are shown in the accompanying drawings. The detailed description uses numerical and alphabetical designations to refer to features in the drawings. Similar or like designations in the drawings and description have been used to refer to similar or like parts of the present disclosure. As used herein, the terms "first", "second", and "third" may be used interchangeably to distinguish one component from another, and are not intended to indicate the position or importance of individual components.

### Embodiments

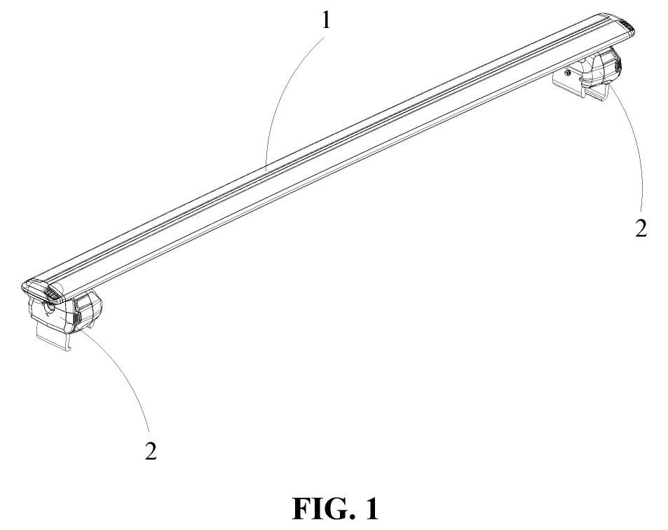

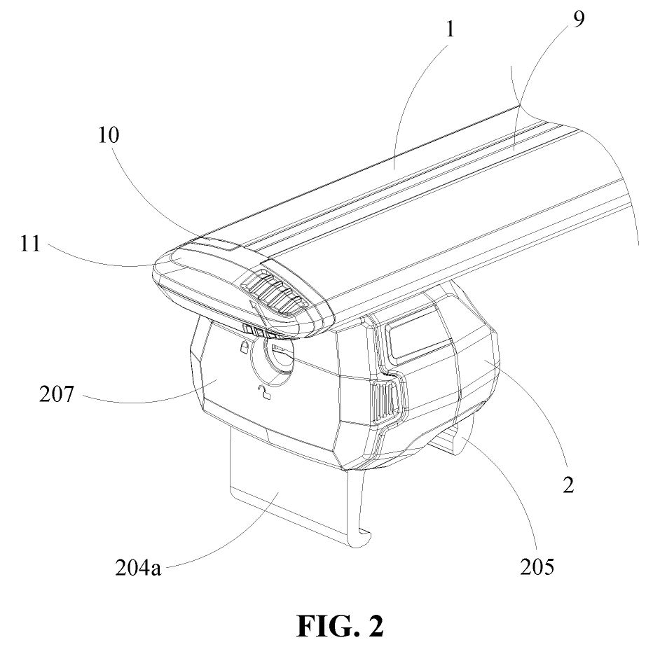

As shown in FIGS. 1 to 6, the embodiment of the present disclosure provides a vehicle roof crossbar, including a crossbar main body 1 and a sliding seat 2.

Preferably, as shown in FIGS. 1 to 3, the crossbar main body 1 is integrally formed by an aluminum alloy extrusion process. The process may effectively ensure a structural strength of the crossbar main body 1 and save production costs as much as possible. A first sliding groove 101 and a second sliding groove 102 are respectively arranged on the bottom and top of the crossbar main body 1 made by the process. The first sliding groove 101 is filled with a mounting strip 7 made by the extrusion molding process, and the second sliding groove 102 is filled with a filling strip 9 made by the extrusion molding process. The mounting strip 7 and the filling strip 9 respectively press against groove walls of their respective sliding grooves through elastic deformation to achieve fixation.

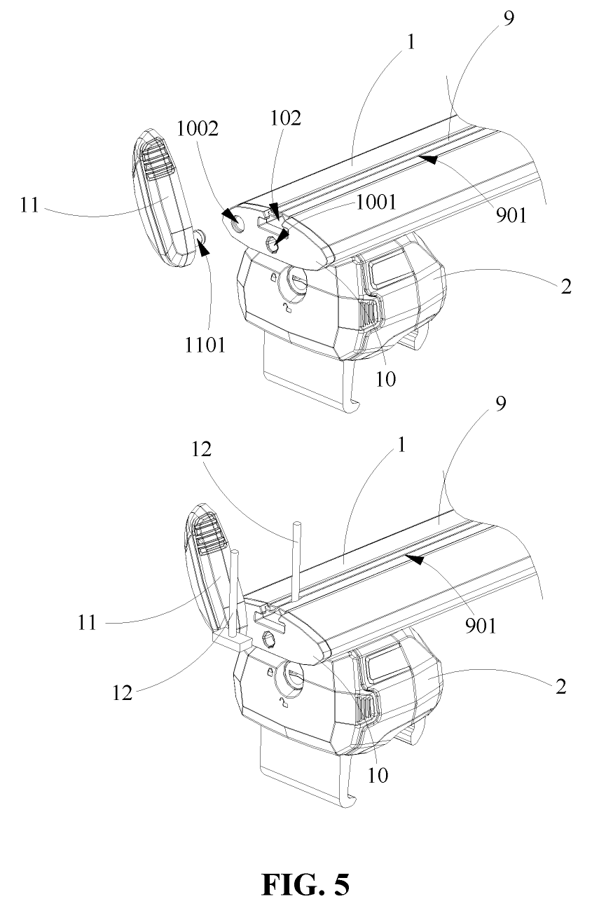

Preferably, as shown in FIG. 5, a strip-shaped gap 901 extending in a same direction as the crossbar main body 1 is formed on the top of the filling strip 9. When a user needs to mount the crossbar main body 1 through a T-shaped screw rod 12, a utility knife or other thin-sheet-shaped mounting tools may be used to scrape the strip-shaped gap 901, and then the corresponding T-shaped screw rod 12 may be slid into along the second sliding rail and the strip-shaped gap 901, with no need for cutting off and refilling the filling strip 9, thereby effectively improving the working efficiency of the installation personnel.

Preferably, as shown in FIGS. 1 to 6, a first slider 201 is arranged on the top of the sliding seat 2, and the first slider 201 defines a third through hole 201a, a second slider 8 and a first slider 201 are sequentially slidably connected in the first sliding groove 101 of the crossbar main body 1, the second slider 8 defines a fourth through hole 801, and a screw rod portion of a second screw rod 6 is sequentially threaded through the fourth through hole 801 and the third through hole 201a and then is in threaded connection with the threaded hole at an end of the mounting strip 7.

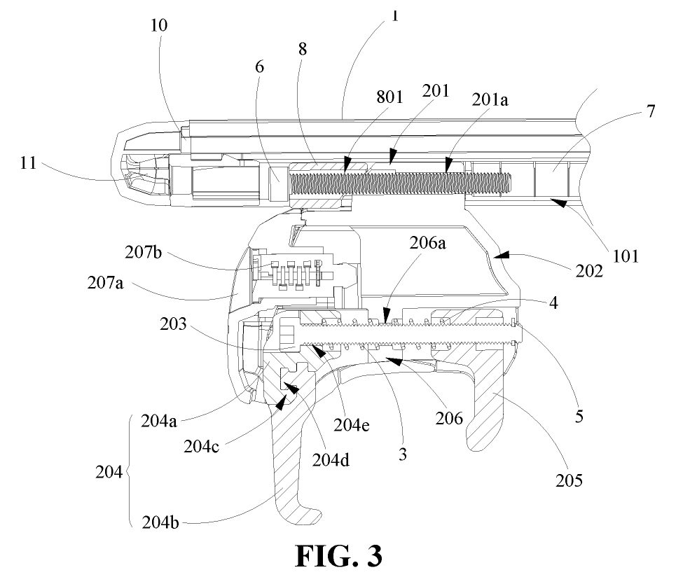

Preferably, as shown in FIG. 3, a side of the second slider 8 proximal to the first slider 201 is provided with a first inclined surface with an angle of 40°, and a side of the first slider 201 proximal to the second slider 8 is provided with a second inclined surface that matches the first inclined surface. When the second screw rod 6 is not in a locked state and under the influence of gravity, there is no relative compression between the first inclined surface and the second inclined surface. At this time, the user may adjust a relative position of the sliding seat 2 on the crossbar main body 1 by sliding. When the user slides the sliding seat 2 to a target position, by locking the second screw rod 6, the first inclined surface on the second slider 8 fits with and abuts against the second inclined surface on the first slider 201, so as to finally form a mutual compressive force. Under the compressive force, the second slider 8 and the first slider 201 respectively press against groove walls of the first sliding groove 101, and finally the sliding seat 2 is fixed.

Preferably, as shown in FIG. 5, a limiting end cover 10 is mounted at an end of the crossbar main body 1, an adjustment hole 1001 and a shaft hole 1002 are formed in the limiting end cover 10, and the adjustment hole 1001 corresponds to a nut portion of the second screw rod 6. After the limiting end cover 10 is mounted, the limiting end cover 10 is configured to cover and protect the first sliding groove 101 and the second sliding groove 102, thereby preventing the sliding seat 2 or the T-shaped screw rod 12 from falling off from the groove body, and adjusting the second screw rod 6 through the adjustment hole 1001.

Preferably, as shown in FIG. 5, a second end cover 11 is arranged on a side, facing away from the crossbar main body 1, of the limiting end cover 10, and the second end cover 11 is rotatably connected to the shaft hole 1002 on the limiting end cover 10 through a pin shaft 1101 on the second end cover 11, such that the second end cover 11 is configured to rotate relative to the limiting end cover 10 through the pin shaft 1101. The second end cover 11 is configured to cover the adjustment hole 1001 on the limiting end cover 10, thereby protecting the adjustment hole 1001 and the second screw rod 6, and preventing non-operators from adjusting the second screw rod 6.

Preferably, as shown in FIG. 3, a limiting structure 206 is arranged inside the seat body 202 of the sliding seat 2, a second through hole 206a is formed in the limiting structure 206, and two ends of the second through hole 206a are respectively connected to the first clamping block 204 and the second clamping block 205 via the first screw rod 203.

Specifically, as shown in FIG. 3, the first clamping block 204 defines a first through hole 204e, the second clamping block 205 defines a threaded through hole, a screw rod portion of the first screw rod 203 is sequentially threaded through the first through hole 204e, the first spring 3, the second through hole 206a, and the second spring 4 and then is in threaded connection with the threaded through hole in the second clamping block 205, and a tail end of the screw rod portion of the first screw rod 203 is buckled through a ring-shaped buckle 5 to prevent the second clamping block 205 from falling off. Two ends of the first spring 3 respectively abut against the first clamping block 204 and an end face of the limiting structure 206 proximal to the first clamping block 204, and two ends of the second spring 4 respectively abut against the second clamping block 205 and an end face of the limiting structure 206 proximal to the second clamping block 205. When the user rotates the first screw rod 203 and under elastic forces of the first spring 3 and the second spring 4, the first clamping block 204 and the second clamping block 205 may approach or move away from each other synchronously, thereby satisfying the requirement of the user for adjusting a spacing between the first clamping block 204 and the second clamping block 205.

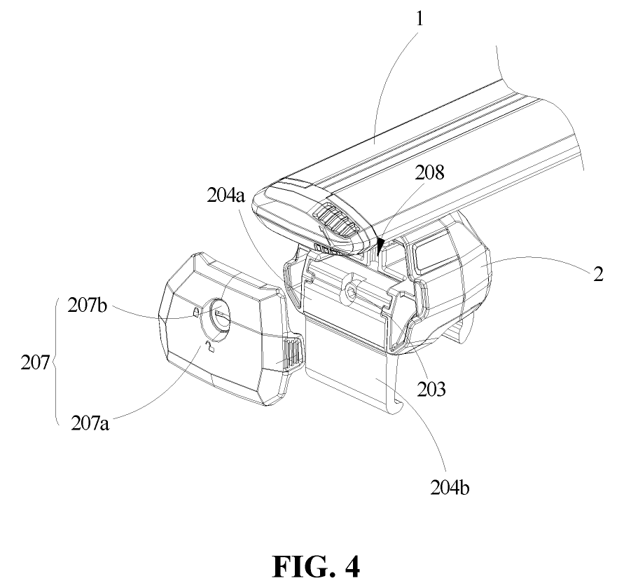

Preferably, as shown in FIG. 4, a locking portion 207 is arranged on a side, proximal to the first clamping block 204, of the seat body 202 of the sliding seat 2, the locking portion 207 includes a first end cover 207a and a lock cylinder 207b arranged on the first end cover 207a, a locking structure 208 is arranged at a position of a side of the sliding seat 2 corresponding to the lock cylinder 207b, and the first end cover 207a is detachably clamped with a side of the seat body 202, such that the first end cover 207a may cover and protect the nut portion of the first screw rod 203, the lock cylinder 207b is adapted to the locking structure 208, and the user may lock or unlock the lock cylinder 207b with a key that matches the lock cylinder 207b. When the lock cylinder 207b and the locking structure 208 are locked with each other, the first end cover 207a may not be separated from the seat body 202, thereby covering and protecting the first screw rod 203 by the locking portion 207, and preventing the non-operators from adjusting or stealing the sliding seat 2. When the lock cylinder 207b and the locking structure 208 are unlocked, the user may remove the first end cover 207a and adjust the spacing between the first clamping block 204 and the second clamping block 205 by rotating the first screw rod 203.

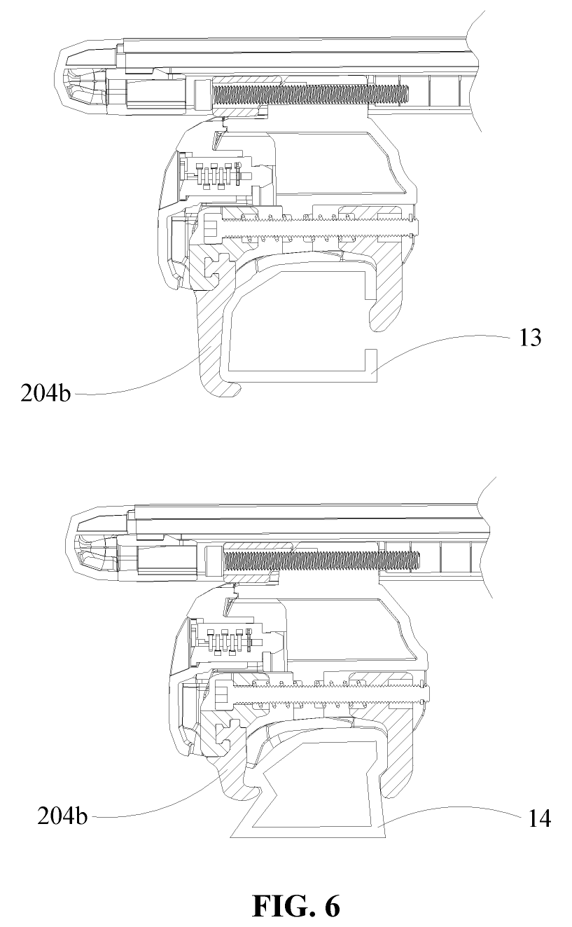

Preferably, as shown in FIG. 6, in the sliding seat 2 of the vehicle roof crossbar, the first clamping block 204 adopts a split-type detachable structure, the first clamping block 204 includes two portions, namely, a connecting block 204a and a clamping block 204b, where the bottom of the connecting block 204a is designed with a first connecting portion 204c in a shape of a clamping groove or a sliding groove, and the top of the clamping block 204b is provided with a second connecting portion 204d matching the first connecting portion 204c and corresponding to the first connecting portion 204c. The clamping block 204b is made by an aluminum alloy extrusion process. Vehicle roof longitudinal rails with different cross-sectional shapes and sizes may be designed with clamping blocks 204b of different length models, and the connecting block 204a and the clamping block 204b may be continuously connected through the first connecting portion 204c and the second connecting portion 204d. With a first vehicle roof longitudinal rail 13 and a second vehicle roof longitudinal rail 14 in the figure as an example, when the user needs to change the requirement of clamping the first vehicle roof longitudinal rail 13 to the requirement of clamping the second vehicle roof longitudinal rail 14, the clamping block 204b in the first clamping block 204 may be removed from the connecting block 204a, and a clamping block 204b with a corresponding shape may be selected for replacement according to a cross-sectional shape of a vehicle roof longitudinal rail to be clamped, so as to satisfy the clamping requirement of vehicle roof longitudinal rails with different cross-sectional shapes.

From the above description, it may be seen that the embodiment of the present disclosure achieves the following technical effects:

Compared with the related art, the vehicle roof crossbar provided in the embodiment of the present disclosure may be adjusted in three ways simultaneously to satisfy the clamping requirement of roof longitudinal rails of various models and sizes. When the user needs to adjust the spacing between the first clamping block 204 and the second clamping block 205 in the sliding seat 2, by rotating the first screw rod 203 and under the elastic forces of the first spring 3 and the second spring 4, the first clamping block 204 and the second clamping block 205 may approach or move away from each other synchronously, thereby adjusting the spacing between the first clamping block 204 and the second clamping block 205. When the user needs to adjust the position of the sliding seat 2 on the crossbar main body 1, by rotating the second screw rod 6 and under the influence of gravity, the first inclined surface on the second slider 8 may be separated from the second inclined surface on the first slider 201. At this time, the second slider 8 may be slid to change a position of the sliding seat 2 on the crossbar main body 1. After the sliding seat 2 is slid to a target position, the second screw rod 6 is rotated and locked, such that the first inclined surface on the second slider 8 fits with and abuts against the second inclined surface on the first slider 201, so as to finally form an interaction force, enable the first slider 201 and the second slider 8 to respectively press against groove walls of the first sliding groove 101 on the crossbar main body 1, and achieve the final fixing effect. When the user needs to clamp vehicle roof longitudinal rails with other cross-sectional shapes, the clamping block 205b in the first clamping block 204 may be removed from the connecting block 204a, and a clamping block 204b with a corresponding shape may be selected for replacement according to the cross-sectional shape of the vehicle roof longitudinal rail to be clamped, so as to satisfy the clamping requirement of roof longitudinal rails with different cross-sectional shapes. A corresponding locking portion 207 is arranged on the sliding seat 2 in the vehicle roof crossbar, and the locking portion 207 covers and protects the first screw rod 203 to prevent non-operators from adjusting or stealing the sliding seat 2. The second sliding groove 102 at the top of the crossbar main body 1 of the vehicle roof crossbar is filled with a filling strip 9 made by an extrusion molding process. The strip-shaped gap 901 is formed on the top of the filling strip 9. When the user needs to mount the crossbar main body 1 through the T-shaped screw rod 12, a utility knife or other thin-sheet-shaped mounting tools may be used to scrape the strip-shaped gap 901, and then the corresponding T-shaped screw rod 12 may be slid into along the second sliding rail 102 and the strip-shaped gap 901, with no need for cutting off and refilling the filling strip 9, thereby effectively improving the working efficiency of the installation personnel.

The above are merely some embodiments of the present disclosure and are not intended to limit the present disclosure. For those skilled in the art, various changes and modifications may be made to the present disclosure. Any modifications, equivalent substitutions and improvements made within the spirit and principles of the present disclosure shall all fall within the protection scope of the present disclosure.

What is claimed is:

1. A vehicle roof crossbar comprising:
a crossbar main body extending along a horizontal direction, wherein a first sliding groove is formed at a bottom of the crossbar main body, and the first sliding groove extends in a same direction as the crossbar main body and runs through two ends in an extension direction of the crossbar main body; and
a sliding seat comprising: a first slider, a seat body, a first screw rod, a first clamping block and a second clamping block, wherein the first slider is arranged on a top of the seat body and is configured to be slidably connected to the crossbar main body, the first screw rod is arranged inside the seat body and extends in the same direction as the crossbar main body, the first screw rod is configured to rotate around its axis relative to the seat body, the first clamping block comprises a connecting block and a clamping block, the connecting block and the second clamping block are sequentially threaded through by the first screw rod, the second clamping block is in threaded connection with the first screw rod, a first connecting portion is arranged at a bottom of the connecting block, a second connecting portion that matches the first connecting portion is arranged on a top of the clamping block, and the connecting block and the clamping block are detachably assembled by the first connecting portion and the second connecting portion;
wherein a spacing between the first clamping block and the second clamping block is adjustable in response to the first screw rod being rotated.

2. The vehicle roof crossbar according to claim 1, wherein:
the sliding seat further comprises a first spring, a second spring and a ring-shaped buckle;
the connecting block defines a first through hole, a limiting structure is arranged inside the seat body, a second through hole is formed in the limiting structure, the first screw rod is sequentially threaded through the first through hole and the second through hole and then is in threaded connection with the second clamping block, and two ends in an extension direction of the second through hole respectively define a first end face and a second end face;
the first spring is threaded through by the first screw rod, and two ends of the first spring respectively abut against the connecting block and the first end face;
the second spring is threaded through by the first screw rod, and two ends of the second spring respectively abut against the second end face and the second clamping block; and
the ring-shaped buckle is buckled with a tail end of the first screw rod.

3. The vehicle roof crossbar according to claim 2, wherein:
the sliding seat further comprises a locking portion, the locking portion comprises a first end cover and a lock cylinder arranged on the first end cover, the first end cover is detachably connected to a side of the seat body to allow the first end cover to cover the first through hole, and a locking structure adapted to the lock cylinder is provided at a position corresponding to the lock cylinder on the seat body.

4. The vehicle roof crossbar according to claim 2, further comprising a second screw rod and a mounting strip;
the mounting strip is placed in the first sliding groove by interference fit, the first slider defines a third throughhole, and the second screw rod is threaded through the third through hole and then is in threaded connection with the mounting strip.

5. The vehicle roof crossbar according to claim 4, further comprising a second slider;
the second slider defines a fourth through hole, the second screw rod is sequentially threaded through the second slider and the first slider and then is in threaded connectionwith the mounting strip, a side of the second slider proximal to the first slider defines a first inclined surface, and a second inclined surface that matches the first inclined surface is defined by the first slider;
wherein the first inclined surface abuts against the second inclined surface in response to the second screw rod being locked.

6. The vehicle roof crossbar according to claim 5, further comprising a filling strip;
a second sliding groove is formed at a top of the crossbar main body, the filling strip is placed in the second sliding groove by interference fit, and a top of the filling strip defines a strip-shaped gap extending in the same direction as the crossbar main body.

7. The vehicle roof crossbar according to claim 6, further comprising a limiting end cover and a second end cover;
the limiting end cover is buckled at an end of the crossbar main body to close an end of the first sliding groove, an adjustment hole and a shaft hole are formed in the limiting end cover, the adjustment hole corresponds to a position of the second screw rod, a pin shaft corresponding to the shaft hole is arranged on the second end cover, and the second end cover is rotatably connected with the shaft hole.
